(19) United States
(12) Patent Application Publication
(10) Pub. No.: US 2007/0104186 A1
(43) Pub. Date: May 10, 2007

(54) System and method for a gatekeeper in a communications network

(75) Inventors: Reto Kramer, Berkeley, CA (US); Anno R. Langen, Berkeley, CA (US); Dhiraj Bhatia, Cupertino, CA (US); Thomas Gronberg, Kil (SE)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/384,056

(22) Filed: Mar. 17, 2006

Related U.S. Application Data
(60) Provisional application No. 60/733,823, filed on Nov. 4, 2005.

(51) Int. Cl. H04L 12/66

(52) U.S. Cl. 370/352; 370/401

(57) ABSTRACT

In accordance with embodiments, there are provided mechanisms and methods for managing services in a communications network. These mechanisms and methods can enable embodiments to manage services provided by third party service providers, for example, to callers establishing communications sessions in a network. The ability of embodiments to control access to, and manage, third party services associated with communications sessions can enable embodiments to provide improved security and enhanced features to callers.

### CLAIM TO PRIORITY

The present application claims the benefit of U.S. Patent Application No. 60/733,823, entitled SYSTEM AND METHOD FOR A GATEKEEPER IN A COMMUNICATIONS NETWORK, by Kramer et al, filed Nov. 4, 2005 (Attorney Docket No. BEAS-01962US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The present United States Provisional Patent Application is related to the following commonly owned, co-pending United States patents and Patent Applications. Each of the other patents/applications are incorporated by reference herein in its entirety:

U.S. Provisional Patent Application No. 60/695,321, entitled SYSTEM AND METHOD FOR MANAGING COMMUNICATIONS SESSIONS IN A NETWORK, by Reto Kramer, et al., filed on Jun. 30, 2005, Attorney Docket No. BEAS-1744US0.

### FIELD OF THE INVENTION

The current invention relates generally to telecommunications, and more particularly to a gatekeeper mechanism for managing services rendered in a communications network.

### BACKGROUND

Conventionally, telecommunications and network infrastructure providers have relied on often decades old switching technology to providing routing for network traffic. Businesses and consumers, however, are driving industry transformation by demanding new converged voice, data and video services. The ability to meet these demands often can be limited by existing IT and network infrastructures that are closed, proprietary and too rigid to support these next generation services. As a result, telecommunications companies are transitioning from traditional, circuit-switched Public Switched Telephone Networks (PSTN), the common wired telephone system used around the world to connect any one telephone to another telephone, to Voice Over Internet Protocol (VoIP) networks. VoIP technologies enable voice communication over “vanilla” IP networks, such as the public Internet. Additionally, a steady decline in voice revenues has resulted in heightened competitive pressures as carriers vie to grow data/service revenues and reduce chum through the delivery of these more sophisticated data services. Increased federal regulation, security and privacy issues, as well as newly emerging standards can further compound the pressure.

However, delivering these more sophisticated data services has proved to be more difficult than first imagined. Existing IT and network infrastructures, closed proprietary network-based switching fabrics and the like have proved to be too complex and too rigid to allow the creation and deployment of new service offerings.

### BRIEF DESCRIPTION OF THE DRAWINGS

FIG. 1 is functional block diagram that shows a high level overview of example services that can be provided to end users in a communications network in an embodiment.

FIG. 2 is a functional block diagram that shows a high level overview of an example service delivery platform in an embodiment.

FIG. 3 is functional block diagram that shows a high level overview of an example logical architecture in which techniques for managing services in a communications network may be embodied.

FIG. 4 is an operational flow diagram illustrating a high level overview of a technique for managing access to services in a communications network in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for managing services in a communications network. These mechanisms and methods can enable embodiments to manage services provided by third party service providers, for example, to callers establishing communications sessions in a network. The ability of embodiments to manage third party services associated with communications sessions can enable embodiments to control access to the network by third party service providers. Some embodiments can provide improved network security. Embodiments with the capability to manage third party services can provide enhanced network features to callers.

In an embodiment, a system for managing services in a communications network is provided. The system embodiment includes a network tier, coupled to a network that receives one or more incoming calls from a caller. The network tier manages a communications session established for the incoming call. The system also includes an application tier that is coupled to one or more third parties that provide services to the communications sessions in the network tier. A gatekeeper is coupled to the network tier and the application tier. The gatekeeper determines whether a call is permitted to access the service(s) in association with the communications session. The gatekeeper can also determine whether the third party that provides the service(s) is permitted to provide the service to the call. The gatekeeper manages the communications session(s) using the network tier and manages the service(s) associated with the one or more communications session(s) using the application tier. Management by the gatekeeper enables the caller to access the one or more service(s) provided by third parties in association with the caller's communications session.

As used herein, the term service is intended to be broadly construed to include any application, program or process resident on one or more computing devices capable of providing services to a requestor or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. As used herein, the term application is intended to be broadly construed to include any data entry, update, query or program that processes data on behalf of a user. Users may be human or computational entities.

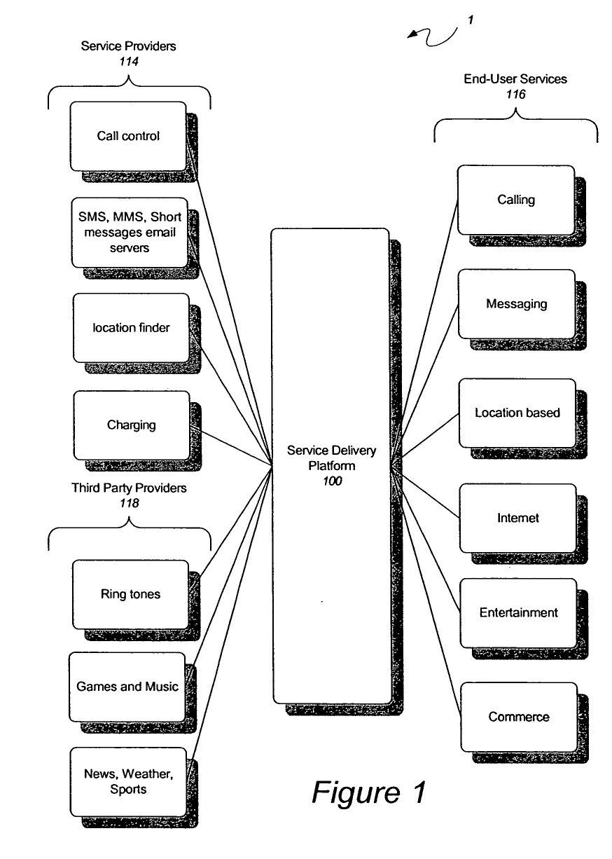

FIG. 1 is functional block diagram that shows a high level overview of example services that can be provided to end users in a communications network in an embodiment. With reference to FIG. 1 and by way of illustration, network system 1 includes a service delivery platform 100 that represents a fully integrated Hyper-Text Transfer Protocol (HTTP), network connections to one or more third party service providers and a network Gatekeeper. (Java™ is a trademark of Sun Microsystems, Inc.) The service delivery platform provides easy to use, integrated, configuration-driven intermediary between service providers 114, end users 116 and third party service providers 118 that accomplishes (without limitation) the following efficiently and with high availability, scalability and reliability:

Provide the capability to provide third party service provider services to callers establishing communications sessions in a network.

Provide the capability to third party provider services to contact callers.

Provide to third party provider's a location, for example, of a caller seeking a service to enable the third party provider to better serve the caller.

Provide the capability to determine a charge to the caller for using the service in association with the at least one communications session.

Service providers 114 and third party service providers 118 provide, by way of example and without limitation, services such as network connectivity, Simple Messaging Service (SMS), Multimedia Messaging Service (MMS), short messages email, location finders, charging (i.e., toll determination), ring tones, games and music, news, weather sports and other services. End Users 116 will access the services made available to them as including, by way of example and without limitation, services such as calling, messaging, location based services, internet, entertainment, commerce and others.

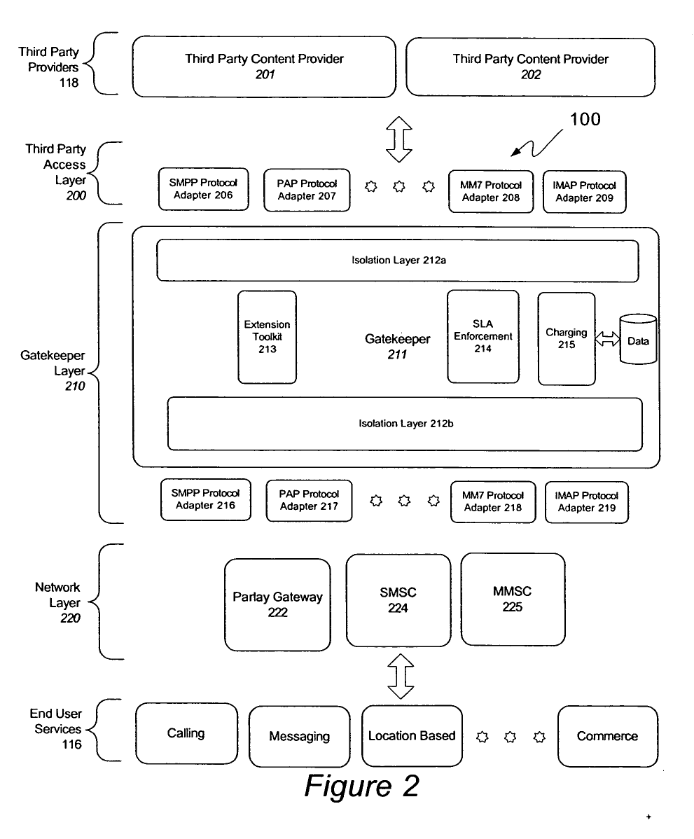

FIG. 2 is a functional block diagram that shows a high level overview of an example service delivery platform in an embodiment. As illustrated by FIG. 2 and by way of example, an embodiment of a service delivery platform 100 provides an easy to use, integrated, configuration-driven intermediary between service providers 114, end users 116 and third party service providers 118. The service delivery platform 100 embodiment illustrated by FIG. 2 comprises a third party access layer 200 to interface with the service providers 114 and third party service providers 118 shown in FIG. 1, a network layer 220 to interface with the end users 116 shown in FIG. 1. Service delivery platform embodiment 100 further comprises a gatekeeper layer 210 interposed between the third party access layer 200 and the network layer 220 for managing and controlling information flowing between layers 200 and 220.

The third party access layer 200 enables third party service providers to make third party services available to callers over a network using the gatekeeper functionality provided by the service delivery platform 100. The third party access layer 200 includes one or more third parties 201, 202 that provide services accessible through a network. In an embodiment, access to services may be achieved using one or more web services protocols. As used herein, the term web services is defined as well-defined protocol interfaces that are used for providing electronic services typically between two enterprise applications over the Internet. One or more protocol adapters 206-209 may be included in order to provide interface mechanism from the third party providers 201, 202 to the network gatekeeper 211 and from the gatekeeper 211 to the applications and services provided by the third party providers 201, 202. While illustrated here with reference to an embodiment comprising specific protocols, Short Message Peer-to-Peer protocol (SMPP) protocol adapter 206, Password Authentication Protocol (PAP) protocol adapter 207, Multimedia Messaging Services (MM7) protocol adapter 208 and Internet Message Access Protocol (IMAP) protocol adapter 209, embodiments may include any number or kind of protocols and are neither limited to, nor required to possess, these illustrated protocol adapters.

The gatekeeper layer 210 enables access control of calls to third party provider services by callers as well as calls made by third party provider services to callers. The gatekeeper layer 210 includes a gatekeeper 211 that comprising a plurality of functional elements. A service level agreement enforcement mechanism 214 provides enforcement of service level agreements (SLAs), e.g., monitoring how many messages customer A sends an hour, if over contract limit, customer A starts paying more or is blocked. In one embodiment, SLA mechanism 214 implements a policy engine and policies that provides capabilities to enter, customize and execute service level agreement provisions as policies. A charging mechanism 215 determines charges to callers for making a call using network resources, e.g., determine charges for network traffic (i.e., calls) according to charging information payment amount/schedule, priorities, and the like. Charging mechanism 215 may access data including Call Data Records (CDR) and/or Event Data Records (EDR) in order to determine charges. In one embodiment, the charging mechanism 215 determines an allocation of charges to be apportioned to the third party providing the service. The gatekeeper layer 210 also includes isolation layers 212a, 212b that provide controlled interface between the gatekeeper 211 and the third party access layer 200 and the network layer 220, respectively. The isolation layers 212a, 212b enable the remainder of the gatekeeper layer 210 functional elements to be isolated from, and unaffected by, the particulars of protocols, interfaces and the like used by applications, services and callers communicating using the network via the gatekeeper 211.

The gatekeeper layer 210 may include one or more protocol adapters 216-219 in order to provide interface mechanism from callers and caller user applications (clients) to the network gatekeeper 211 and from the gatekeeper 211 to the callers and caller user applications. While illustrated here with reference to an embodiment comprising specific protocols, SMPP protocol adapter 216, PAP protocol adapter 217, MM7 protocol adapter 218 and IMAP protocol adapter 219, embodiments may include any number or kind of protocols and are neither limited to, nor required to possess, these illustrated protocol adapters. An extension toolkit 213 enables partners to develop other protocol adapters for inclusion into the gatekeeper layer 210.

The Network layer 220 enables inclusion of follow-on network elements that replace traditional class 4 or class 5 switches, as well as Softswitches, and “vertical applications”. Network layer 220 includes a Parlay (protocol) gateway 222 that provides interface with the third party access layer 200 and the gatekeeper layer 210 such as IMS (IP multi-media subsystem) 223, SMSCs (short-message-service-center) 224 and MMSCs (multi-media messaging service center) 225.

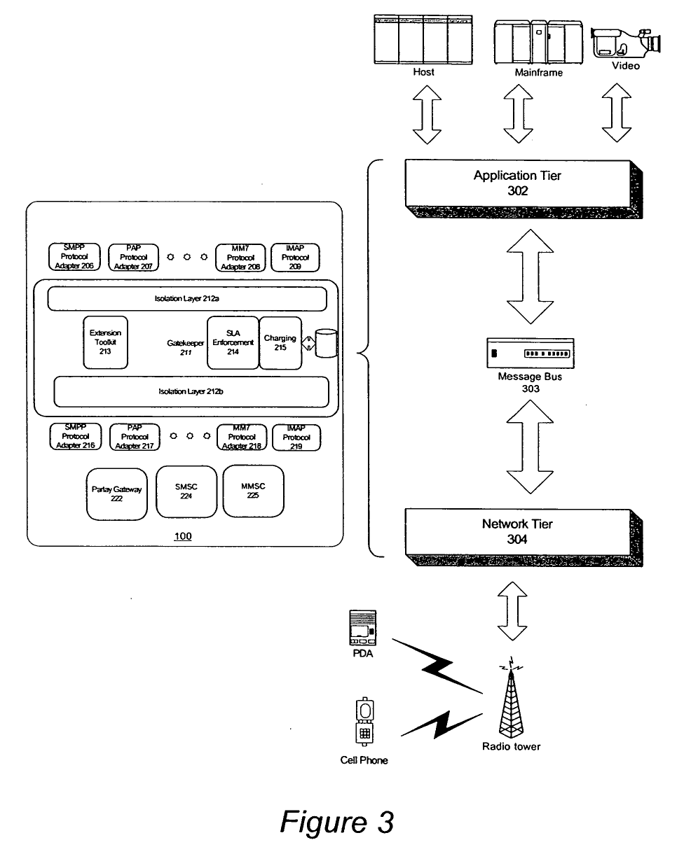

FIG. 3 is functional block diagram that shows a high level overview of an example logical architecture in which techniques for managing services in a communications network may be embodied. By way of example and as illustrated by FIG. 3, service delivery platform 100 of FIGS. 1-2 may be implemented using multi-tier system architecture. As shown in FIG. 3, the system architecture provides independent, coordinated execution of business logic implementing services and the like, executing in one tier, and communications connection management logic which executes in a second tier. An application tier 302 comprises machines capable of executing applications, including applications provided by third parties, on behalf of callers that initiate communications sessions managed by the network tier 304. In an embodiment, an interconnection mechanism 303 provides an interconnection between network elements of application tier 302 and network tier 304. In an example embodiment, interconnection mechanism 303 comprises Java Messaging Service (JMS). In an alternate embodiment, interconnection mechanism 303 is implemented using Common Object Object Request Broker Architecture (CORBA), a group of application programming interfaces (APIs), communication protocols, and object/service information models to enable heterogeneous applications written in various languages running on various platforms to interoperate.

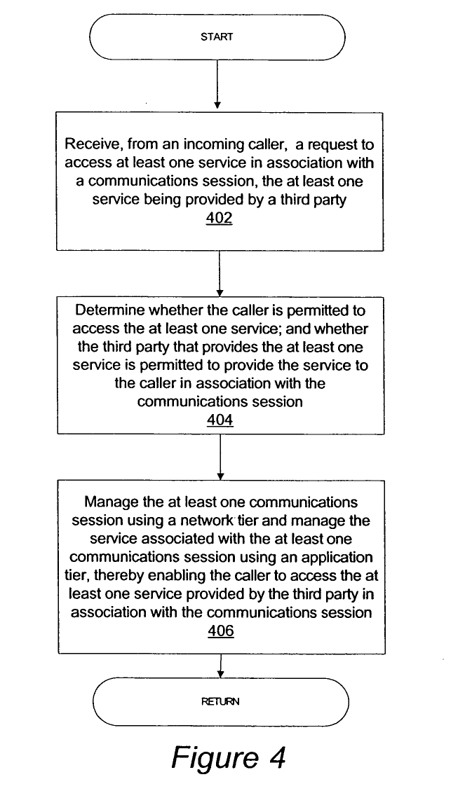

FIG. 4 is an operational flow diagram illustrating a high level overview of a technique for managing access to services in a communications network in an embodiment. The technique for managing communications sessions in a network shown in FIG. 4 is operable with gatekeeper layer 210 of FIG. 2, for example. As shown in FIG. 4, a request to access at least one service in association with a communications session, is received from an incoming caller in block (402). The at least one service is provided by a third party. A gatekeeper determines whether the caller is permitted to access the at least one service; and whether the third party that provides the at least one service is permitted to provide the service to the caller in association with the communications session in block (404). The at least one communications session is managed using a network tier and the service associated with the at least one communications session is managed using an application tier (block 406). The foregoing method embodiment can enable the caller to access the at least one service provided by the third party in association with the communications session.

Various embodiments may be implemented using a conventional general purpose or specialized digital computer(s) and/or processor(s) programmed according to the teachings of the present disclosure, as can be apparent to those skilled in the computer art. Appropriate software coding can readily be prepared by skilled programmers based on the teachings of the present disclosure, as can be apparent to those skilled in the software art. The invention may also be implemented by the preparation of integrated circuits and/or by interconnecting an appropriate network of conventional component circuits, as can be readily apparent to those skilled in the art.

Embodiments can provide, by way of example and without limitation, services such as:

VoIP services, including, without limitation the following features:

Basic features. These include standards services such as Voice mail, Caller ID, Call waiting, and call forwarding (the ability to forward a call to a different number).

Advanced features. The list of advanced features is operators specific. Following is a brief list of advanced features:

Call logs: The ability to view calls made over a given period of time online, ability to associate names with phone numbers, integrate call log information to other applications such as IM.

Do not disturb: The ability to specify policies around receiving calls—for example, all calls during office hours to be automatically forwarded to a mobile terminal, all calls during the night to be directed to voice mail etc.

Locate me: This is advanced call forwarding. Rather than have all calls forwarded to a single location (e.g., voice mail) when the caller is busy, Locate me can try multiple terminals in series or in parallel. For example, a user may have two office locations, a mobile, and a pager, and it may make sense to forward a call to both office locations first, then the pager, and then the mobile terminal. Locate me is another example of feature interaction.

Personal conferencing: A user could use an existing application (e.g., IM client) to schedule a Web/audio conference to start at a certain time. Since the IM client already has personal profile information, the conferencing system sends out the Web conference link information either through IM and/or email to the participants. The phone contact information in the profile is used to automatically ring the participants at the time of the conference.

Lifetime number: This is the facility where a single virtual number can travel with a customer wherever they live. Even if they move, the old number continues to work, and reaches them at their new location. This is really the analog of static IP addresses in a phone network.

Speed dial: This is the ability to dramatically expand the list of numbers that can be dialed through short-key and accelerator combinations. This is another example of a converged application, since it's very likely that when a user will set up this information when they work through the call logs on the operator user portal, and the updated information needs to be propagated to the network side in real-time.

Media delivery services, including, without limitation the following features:

Depending on the service level agreement users are willing to sign up to, the quality of media delivered (e.g. # of frames per second) will vary. The policy engine enables segmenting the customer base by revenue potential, and to maximize return on investment made in the network

Context-sensitive applications including, without limitation the following features:

A typical example here is the need for applications that have a short lifetime, extremely high usage peaks within their lifetime, and immediacy. For example, voting on American Idol during the show or immediately afterwards has proved to be an extremely popular application.

Integrated applications including, without limitation the following features:

The final class of applications is one which combines wireline and wireless terminal usage scenarios. An example integrated application is the following: a mobile terminal user is on a conference call on their way to work. When he reaches his office, he enters a special key sequence to transfer the phone call to his office phone. The transfer happens automatically without the user having to dial in the dial-in information again. It's important to note hear that this capability be available without the use of any specific support from the hand-set (a transfer button for example).

Various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, microdrives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

1. A method for managing services in a communications network, the method comprising:
receiving, from an incoming caller, a request to access at least one service in association with a communications session, the at least one service being provided by a third party;
determining whether the caller is permitted to access the at least one service; and whether the third party that provides the at least one service is permitted to provide the service to the caller in association with the communications session; and
managing the at least one communications session and managing the service associated with the at least one communications session, thereby enabling the caller to access the at least one service provided by the third party in association with the communications session.

2. The method of claim 1, wherein receiving, from an incoming caller, a request to access at least one service in association with a communications session, the at least one service being provided by a third party comprises:
receiving a web services request to access a service.

3. The method of claim 2, wherein receiving a web services request to access a service comprises:
receiving a request via at least one of IMS (IP multi-media subsystem), SMSCs (short-message-service-center), MMSCs (multi-media messaging service center) and a telephone switch.

4. The method of claim 1, determining whether the caller is permitted to access the at least one service; and whether the third party that provides the at least one service is permitted to provide the service to the caller in association with the communications session comprises:
determining whether the caller is permitted to access the at least one service under a service level agreement.

5. The method of claim 4, wherein determining whether the caller is permitted to access the at least one service under a service level agreement comprises:
checking a service policy implementing the service level agreement.

6. The method of claim 1, wherein managing the at least one communications session using a network tier and manage the service associated with the at least one communications session, thereby enabling the caller to access the at least one service provided by the third party in association with the communications session comprises:
determining a charge to the caller for using the service in association with the at least one communications session.

7. The method of claim 6, wherein determining a charge to the caller for using the service in association with the at least one communications session comprises:
determining an allocation of charges to be apportioned to the third party providing the service.

8. The method of claim 1, further comprising:
receiving, from a third party service, a request to initiate a communications session with a caller.

9. The method of claim 8, wherein receiving, from a third party service, a request to initiate a communications session with a caller comprises:
receiving, from a third party service, a request to initiate a communications session with a caller, the request comprising at least one of: Short Message Peer-to-Peer protocol (SMPP), Password Authentication Protocol (PAP), Multimedia Messaging Services (MM7) protocol and Internet Message Access Protocol (IMAP).

10. The method of claim 8, further comprising:
determining whether the service is permitted to establish communications with the caller; and
providing a location of the caller to the third party service when the service is permitted to establish communications with the caller.

11. The method of claim 1, wherein managing the at least one communications session and managing the service associated with the at least one communications session, comprises:
managing the at least one communications session using a network tier and managing the service associated with the at least one communications session using an application tier.

12. A system for managing services in a communications network, the system comprising:
a network tier, coupled to a network that receives at least one incoming call from a caller; wherein the network tier manages at least one communications session established for the at least one incoming call;
an application tier, coupled to at least one third party that provides at least one service to the at least one communications session in the network tier; and
a gatekeeper, coupled to the network tier and the application tier, wherein the at gatekeeper determines whether the call is permitted to access the at least one service; and whether the third party that provides the at least one service is permitted to provide the service to the call in association with the communications session; and wherein the gatekeeper manages the at least one communications session using the network tier and manage the service associated with the at least one communications session using the application tier, thereby enabling the caller to access the at least one service provided by the third party in association with the communications session.

13. The system of claim 12, wherein the network tier, coupled to the network that receives at least one incoming call from a caller, receives a web services request to access a service.

14. The system of claim 13, wherein the web services request to access a service further comprises:
a request made via at least one of IMS (IP multi-media subsystem), SMSCs (short-message-service-center), MMSCs (multi-media messaging service center) and a telephone switch.

15. The system of claim 12, wherein the gatekeeper that determines whether the call is permitted to access the at least one service; and whether the third party that provides the at least one service is permitted to provide the service to the call in association with the communications session:
determines whether the caller is permitted to access the at least one service under a service level agreement.

16. The system of claim 15, wherein the gatekeeper that determines whether the caller is permitted to access the at least one service under a service level agreement:
checks a service policy implementing the service level agreement.

17. The system of claim 12, wherein the gatekeeper that manages the at least one communications session:
determines a charge to the caller for using the service in association with the at least one communications session.

18. The system of claim 17, wherein the gatekeeper that determines a charge to the caller for using the service in association with the at least one communications session:
determines an allocation of charges to be apportioned to the third party providing the service.

19. The system of claim 12, further comprising:
the gatekeeper receiving, from a third party service, a request to initiate a communications session with a caller.

20. The system of claim 19, wherein the gatekeeper receiving, from a third party service, a request to initiate a communications session with a caller comprises:
the gatekeeper receiving, from a third party service, a request to initiate a communications session with a caller, the request comprising at least one of: Short Message Peer-to-Peer protocol (SMPP), Password Authentication Protocol (PAP), Multimedia Messaging Services (MM7) protocol and Internet Message Access Protocol (IMAP).

21. The system of claim 19, further comprising:
the gatekeeper determining whether the service is permitted to establish communications with the caller.

22. A computer-readable medium carrying one or more sequences of instructions for managing communications sessions, which instructions, when executed by one or more processors, cause the one or more processors to carry out the steps of:
receiving, from an incoming caller, a request to access at least one service in association with a communications session, the at least one service being provided by a third party;
determining whether the caller is permitted to access the at least one service; and whether the third party that provides the at least one service is permitted to provide the service to the caller in association with the communications session; and
managing the at least one communications session and managing the service associated with the at least one communications session, thereby enabling the caller to access the at least one service provided by the third party in association with the communications session.
